(19) United States
(12) Patent Application Publication
(10) Pub. No.: US 2007/0238475 A1
(43) Pub. Date: Oct. 11, 2007

(54) Wireless communications device with priority list

(76) Inventor: Terrance J. Goedken, Mundelein, IL (US)

Correspondence Address: MOTOROLA INC, 600 NORTH US HIGHWAY 45, ROOM AS437, LIBERTYVILLE, IL, 60048-5343, US

(21) Appl. No.: 11/394,305

(22) Filed: Mar. 30, 2006

(51) Int. Cl. H04B 7/00; H04Q 7/20

(52) U.S. Cl. 455/512; 455/41.2

(57) ABSTRACT

An improved wireless communications device (12,14,15,16,18) and method of operating such a device (60) is disclosed. In at least some embodiments, the wireless communications device includes a transceiver (32), a memory (36) on which is stored a list of devices with which the wireless communications device can potentially communicate (26), and a processing device (34) coupled at least indirectly to the transceiver and the memory. The processing device (34) identifies a plurality of devices on the list (26) that are presently available for communications with the wireless communications device (68). Also, the processing device (34) causes the wireless communications device to communicate with a selected one of the identified devices, the selected one identified device being that one of the identified devices which has a relative highest rank on the list (70,72).

### FIELD OF THE INVENTION

The present invention relates to wireless communications systems, particularly short-range wireless communication systems.

### BACKGROUND OF THE INVENTION

Wireless devices such as cellular telephones, pagers, personal digital assistants, and other handheld devices are ubiquitous in the modern world. Although such devices are commonly designed for long-range communications (e.g., communications between a cell phone and a cell tower), in recent years efforts have been made to develop wireless devices that are capable of communicating with numerous other wireless devices that are within a relatively short range.

Of particular prominence in this regard has been the development of the BlueTooth wireless technology, which to date includes at least two versions, Version 1.2 (adopted in November, 2003) and Version 2.0+Enhanced Data Rate (EDR) (adopted in November, 2004). This wireless technology makes it possible for multiple wireless devices that are sufficiently close to one another to sense one another's presence, to establish a wireless communication network among one another, and to transmit data among and otherwise communicate with one another. The overall wireless communications system automatically adapts to changes in the number and identities of the wireless devices that are in sufficient proximity with one another.

Although the BlueTooth wireless technology is successful in facilitating communications among multiple wireless devices that are in close proximity to one another, the rate of data transmission between wireless devices employing conventional BlueTooth technology is limited by the bandwidth of the technology. As a result, in circumstances where high data transfer rates are required, it is sometimes necessary to impose restrictions upon the communications occurring among the wireless devices. For example, where audio content streaming is desired among the wireless devices forming a BlueTooth wireless communications network, only two wireless devices are allowed to communicate with one another at any given time notwithstanding the presence of other wireless devices on the network.

Such restrictions can be burdensome insofar as they can necessitate involvement on the part of a human user to achieve a desired result. For example, if a user desires that audio content be provided from a first wireless device such as a cell phone to a particular second wireless device such as a stereo headset while those two wireless devices are further in proximity with other wireless devices such as an automobile stereo, it will typically be necessary that the user manually turn off those other wireless devices in order to guarantee that the audio content is provided to the desired (in this case, second) wireless device (namely, the stereo headset). Without such manual intervention by the user, the audio content will be directed in an unpredictable manner to any one of the various wireless devices that are in proximity with one another.

For at least these reasons, therefore, it would be advantageous if an improved wireless device could be developed for use in short-range wireless communications networks such as those achieved by way of the BlueTooth technology. More particularly, it would be advantageous if such an improved wireless device was capable of operating in a manner that guaranteed (or improved the likelihood) that the wireless device would interact with other nearby wireless devices in a desired manner notwithstanding restrictions necessitated by the required data transfer rate among the devices, and yet did not require as much user intervention to achieve the desired manner of operation as is required when using conventional wireless devices.

### BRIEF SUMMARY OF THE INVENTION

The present inventor has recognized the desirability of an improved wireless device and further recognized that such an improved wireless device could be achieved in at least some embodiments by equipping the wireless device with a priority list or similar ordering mechanism. For example, by providing such a priority list or similar ordering mechanism to the wireless device, the wireless device could be configured to automatically select an appropriate recipient for its transmitted information in circumstances where it was only possible or appropriate to transmit the information to a single recipient (or a limited number of recipients). Further, such a priority list allows the wireless device to make proper selections even though, at different times, the wireless device is in communication with different numbers or types of other wireless or even non-wireless devices.

In at least some embodiments, the present invention relates to a method of operating a first wireless communications device. The method includes determining which of a plurality of devices identified on a list associated with the first wireless communications device are presently capable of intercommunications with the first wireless communications device, selecting one of the devices that are presently capable of intercommunications with the first wireless communications device as a highest-ranking device based upon a ranking established by the list, and operating the first wireless communications device to achieve intercommunications with the highest-priority device.

Additionally, in at least some embodiments, the present invention relates to a wireless communications device that includes a transceiver, a memory on which is stored a list of devices with which the wireless communications device can potentially communicate, and a processing device coupled at least indirectly to the transceiver and the memory. The processing device identifies a plurality of devices on the list that are presently available for communications with the wireless communications device. Also, the processing device causes the wireless communications device to communicate with a selected one of the identified devices, the selected one identified device being that one of the identified devices which has a relative highest rank on the list.

Further, in at least some embodiments, the present invention relates to a primary wireless communications device. The primary wireless communications device includes means for determining a presence of a plurality of secondary wireless communications devices that are capable of communications with the primary wireless communications device. The primary wireless communications device additionally includes means for selecting a preferred other device from among a plurality of other devices, the plurality of other devices including the secondary wireless communications devices, and means for communicating information with the preferred other device.

### BRIEF DESCRIPTION OF THE DRAWINGS

FIG. 1 is a schematic diagram illustrating exemplary interconnections among exemplary wireless devices of an exemplary wireless communications system, in which one of the wireless devices includes an exemplary priority list that governs a priority of communications among the wireless devices;

FIG. 2 is a block diagram showing exemplary components of the wireless device of FIG. 1 that includes the priority list; and

FIG. 3 is a flow chart showing exemplary steps of operation of the wireless communications system of FIG. 1.

### DETAILED DESCRIPTION OF THE PREFERRED EMBODIMENT

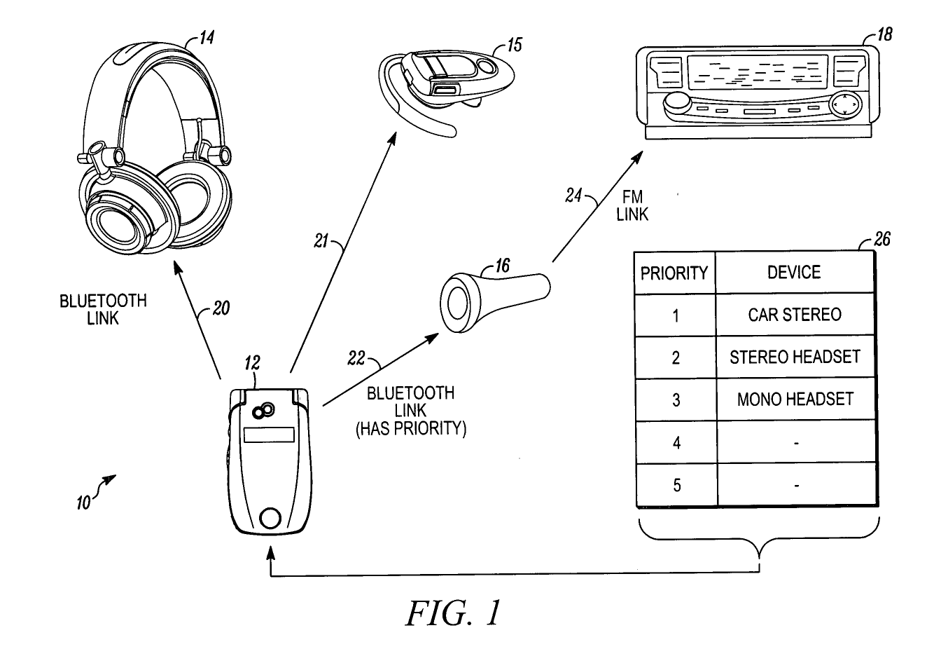

Referring to FIG. 1, an exemplary BlueTooth wireless communications system 10 is shown to include multiple wireless communications devices that are capable of directly (or at least indirectly) intercommunicating with one another in accordance with a form of the BlueTooth wireless technology (e.g., according to one of the BlueTooth specifications or standards). As such, the wireless devices are designed to form, and to communicate wirelessly with one another via, short-range, ad hoc networks (e.g., piconets). The wireless devices in the present example are class 2 radios having a range of up to 10 meters or about 30 feet in terms of their BlueTooth communications capability, albeit in other embodiment class 3 radios having a range of only up to one meter or three feet, or class 1 radios having a range of up to 100 meters or about 300 feet, could also be employed. The devices transmit signals in the BlueTooth RF layer, which is at a frequency band around approximately 2.4 GHz. Each of the wireless devices is capable of communicating a variety of types of data such as, among other things, voice data, audio data, audio streaming data, image data, alphanumeric data, and data to be printed or faxed.

The present BlueTooth system is intended to be representative of BlueTooth wireless systems using any of the various existing (or future) BlueTooth specifications including, for example, Version 1.2 (adopted November, 2003) and Version 2.0 Plus Enhanced Data Rate (EDR) (adopted November, 2004). The present embodiment of the invention preferably employs BlueTooth wireless technology since BlueTooth technology is particularly robust, low in its power use, and low cost, and also is already well-established in the marketplace. Nevertheless, the present invention is also intended to encompass a variety of other types of wireless communications systems and wireless devices that intercommunicate by way of technologies other than the BlueTooth wireless technology. For example, in some alternate embodiments, communications could occur in accordance with any of the IEEE 802.11 specification, the HomeRF specification, a wireless personal-area network (WPAN) technology or a wireless local-area network (WLAN) technology.

As shown in FIG. 1, in the present exemplary embodiment the BlueTooth wireless communications system 10 includes several wireless devices. Among these are a cellular telephone 12, a stereo headset 14, a mono headset 15, and a BlueTooth conversion device or adapter 16. Each of these devices could take many different particular forms, for example, the stereo headset 14 could be a Motorola HT820 BlueTooth stereo headset available from Motorola, Inc., of Schaumburg, Ill.

Further as shown in FIG. 1, an additional device, namely, a car stereo 18, is also included within the wireless communication system 10. While the cellular telephone 12, the stereo headset 14, mono headset 15, and the BlueTooth adapter 16 are all BlueTooth devices that are capable of communicating directly with one another by way of the BlueTooth wireless technology, the car stereo 18 is not a BlueTooth device. Rather, the car stereo 18 is in wireless communications with the BlueTooth adapter 16 by way of another communications technology (e.g., FM radio communications), and is only indirectly in communication with the other wireless devices 12, 14, 15 by way of the BlueTooth technology. Thus, while FIG. 1 shows the cellular telephone 12 to be in communication with the stereo headset 14, the mono headset 15, and the BlueTooth adapter 16 by way of first, second, and third BlueTooth links 20, 21, and 22, respectively, FIG. 1 shows the car stereo 18 to be in communication with the BlueTooth adapter 16 by way of an alternate communications (e.g., FM) link 24. In short, although the wireless communications system 10 is termed a BlueTooth wireless communications system, it will be understood that not all of the devices need be BlueTooth devices in every embodiment; rather, in at least some embodiments such as the present embodiment, the BlueTooth wireless communications system can include, in addition to several BlueTooth-ready devices, several other devices that are in communication with those BlueTooth devices by way of other wireless or non-wireless links.

As further indicated in FIG. 1 (particularly by the arrowheads of the links 20, 21, 22 and 24), the devices within the wireless communications system 10 are not of equal rank. Rather, the cellular telephone 12 has a highest rank within the wireless communication system (and also specifically among the BlueTooth devices), while the stereo headset 14, mono headset 15, BlueTooth adapter 16 and car stereo 18 are of lesser rank. This hierarchy of the devices within the wireless communication system 10 simply is reflective of the fact that it is the cellular telephone 12 that is, in this embodiment, capable of supplying audio information to any one or more of the stereo headset 14, the mono headset 15, the BlueTooth adapter 16, and (by way of the adapter) the car stereo 18. The audio information available from the cellular telephone 12 can be provided thereto in a variety of ways including, for example, downloading of that information by the cellular telephone from a general cellular network (not shown) with which the cellular telephone is in communication. Alternatively, the cellular telephone 12 could be programmed with that information, or otherwise that information could be downloaded onto the cellular telephone in other manners.

Notwithstanding the fact that the cellular telephone 12 has a higher rank than any of the other wireless devices 14, 15, 16 and 18 of the wireless communication system 10, this in and of itself is not sufficient to determine how information is transmitted from the cellular telephone 12 to the other devices 14, 15, 16 and 18 under certain circumstances. For example, as discussed above in the Background of the Invention, if the wireless communication system 10 were configured in a conventional manner, it would in at least some circumstances be unpredictable as to whether information was transmitted from the cellular telephone 12 to the stereo headset 14, to the mono-headset 15, or to the BlueTooth adapter 16 unless a user manually shut off two of those devices such that only the remaining one of the three devices was still operating and capable of receiving the information from the cellular telephone 12.

To improve the predictability of operation of the wireless communications system 10 under such circumstances, in accordance with at least some embodiments of the present invention, the cellular telephone 12 includes/stores a BlueTooth priority list 26. By consulting with this priority list 26, the cellular telephone 12 is able to determine conclusively which of the other devices of the wireless communication system 10 should be the recipient of information at times when it is not possible or appropriate to treat all of those other device the same. For example, in a situation where the cellular telephone 12 is intending to provide audio streaming information to one or more of the other wireless devices, and due to bandwidth requirements (or some other reason) it is not possible for this information to be provided to more than one of the other wireless devices simultaneously, the cellular telephone 12 consults the priority list 26 to determine the most desired recipient of the audio streaming information and only sends the information to that recipient.

More particularly, in the present example, the priority list 26 lists the car stereo 18 as being first in priority, the stereo headset 14 as being second in priority and the mono headset 15 as being third in priority. Thus, in accordance with this priority list, when the cellular telephone 12 determines that it is in communication with each of the stereo headset 14, the mono headset 15, and the car stereo 18 (indirectly by way of the BlueTooth adapter 16), the cellular telephone 12 interacts with the BlueTooth adapter 16 such that audio information is transmitted to the car stereo 18 by way of the BlueTooth link 22 and the FM link 24. However, if the BlueTooth adapter 16 is subsequently switched off or otherwise goes out of range of the cellular telephone 12, such that the car stereo 18 is effectively no longer present as a recipient of information from the cellular telephone 12, then the telephone supplies the audio information to the stereo headset 14 and, if the stereo headset is also switched off or goes out of range, then the telephone provides the information to the mono headset 15.

Also, in the present embodiment, if the BlueTooth adapter 16 is present and operational even though the car stereo 18 is switched off (or otherwise not present), the cellular telephone 12 presumes that the car stereo is still present and sends information to the BlueTooth adapter. Nevertheless, in alternate embodiments the system could operate in another fashion. For example, in some such embodiments the BlueTooth adapter 16 can determine the presence of the car stereo 18 and provide an indication to the cellular telephone 12 as to whether the car stereo is present. In such case, in the event that the BlueTooth adapter 16 is in communication with the cellular telephone 12 and the car stereo 18 is not present or operational, the adapter will communicate that fact to the cellular telephone 12 and the cellular telephone will then proceed to choose the next highest-priority device from the priority list 26 as its intended recipient.

Further for example, in some alternate embodiments the BlueTooth adapter 16 can itself be a legitimate recipient of information from the cellular telephone 12, and could itself be listed on the priority list 26. In such case, the cellular telephone 12 could be provided with information from the BlueTooth adapter as to the presence of the car stereo 18 and, if both the car stereo and the adapter were present, send information to the BlueTooth adapter with a further instruction that the information either be utilized by the BlueTooth adapter or forwarded on to the car stereo based upon the relative priority of the devices in the priority list.

Additionally, in still some other embodiments, the BlueTooth adapter 16 could itself determine whether the cellular telephone 12 was made aware of the presence of the car stereo 18 or not. For example, the BlueTooth adapter 16 could include an operator switch where, in one position, the BlueTooth adapter was configured to relay information received from the cellular telephone 12 to the car stereo and, in another position, the BlueTooth adapter was configured to not relay such information. Thus, the present invention not only is intended to encompass BlueTooth systems in which one BlueTooth device is directly in communication with other BlueTooth devices, but also is intended to encompass BlueTooth systems in which one BlueTooth device is in communication with serially-connected strings of devices, where intermediate devices along any given string potentially can play any of a variety of roles (e.g., an intermediate device can be merely an intermediate relay station, a legitimate recipient of information that can be listed on a priority list such as the priority list 26, or a device that influences or controls what information is communicated to or from subsequent devices along the string of devices).

The priority list 26 shown in FIG. 1 is intended to be exemplary of numerous possible priority lists or other ordering features (e.g., data structures or matrices) that can be employed on a cellular telephone such as the cellular telephone 12 or on a variety of other wireless devices (whether BlueTooth devices or not), or even on a variety of devices that are only indirectly in communication with wireless devices. The particular devices listed on the priority list 26 of FIG. 1 also are only exemplary; that is, the devices listed on the priority list in any given embodiment will depend upon the identities of devices that are part of, or expected to possibly be part of, the wireless communications system. Also, for example, while the priority list 26 is a device priority list in which different potential devices (which can but need not all be wireless devices) are hierarchically ordered, in other embodiments a priority list of different possible attributes, functions or types of data could also be utilized. Further, while the priority list 26 is implemented on the cellular telephone 12 in the case of the exemplary wireless communication system 10 of FIG. 1, in other embodiments where another wireless device held the highest hierarchical rank within the wireless communication system, the priority list 26 would typically reside elsewhere. Nevertheless, it is also possible in alternate embodiments that a device not having the highest hierarchical rank would store and use a priority list, and/or that a device's hierarchical rank would vary over time or in dependence upon operational circumstances.

While the priority list 26 in the present embodiment has exactly the same number of listed items as there are subsidiary wireless devices within the wireless communication system 10 (e.g., three devices, with the car stereo 18 in the present embodiment being considered as a unit together with the BlueTooth adapter 16), it should be understood that the priority list 26 often, if not typically, will include a larger number of listed items than the actual number of wireless devices that form a given wireless communications system at any given time. For example, the priority list 26 will still be appropriate for use in conjunction with the cellular telephone 12 even in situations where the car stereo 18 and BlueTooth adapter 16 are not present, e.g., when the cellular telephone is located within the home of a user who also owns a stereo headset and a mono headset 15, remote from any automobile. Although not necessarily the case, the priority list 26 preferably is configured to list all possible wireless communications devices that can potentially be in communication with the highest ranking device (e.g., the cellular telephone 12) in a variety of operational circumstances.

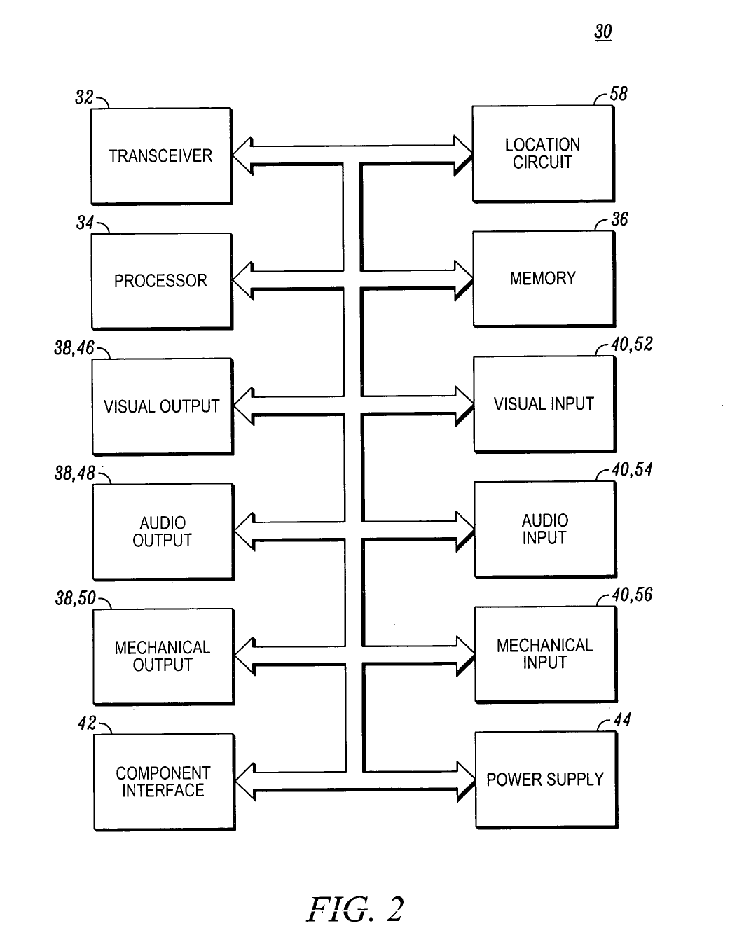

Turning to FIG. 2, there is provided a block diagram illustrating exemplary internal components 30 of the cellular telephone 12 of FIG. 1. Although particularly intended to be representative of the internal components of the cellular telephone 12, the block diagram is also representative of the internal components of other wireless or mobile devices, for example, the stereo headset 14, mono headset 15 or BlueTooth adapter 16 of FIG. 1. As shown, the internal components 30 include one or more wireless transceivers 32, a processor 34, a memory portion 36, one or more output devices 38, and one or more input devices 40. The processor 34 can be any of a variety of different processing devices including, for example, a microprocessor. In at least some embodiments, the internal components 30 include a user interface (not shown) that comprises the output devices 38 and the input devices 40. Each transceiver 32 can utilize wireless technology for communication, such as the BlueTooth technology described above. The internal components 30 can further include a component interface 42 to provide a direct connection to auxiliary components or accessories for additional or enhanced functionality. The internal components 30 preferably also include a power supply 44, such as a battery, for providing power to the other internal components while enabling the overall cellular telephone to be portable.

The internal components 30 can operate in conjunction with one another to perform a number of functions. For example, upon reception of wireless signals, the internal components 30 detect communication signals and the transceiver 32 demodulates the communication signals to recover incoming information, such as voice data and/or other data, transmitted by the wireless signals. After receiving the incoming information from the transceiver 32, the processor 34 formats the incoming information for the one or more output devices 38. Similarly, for transmission of wireless signals, the processor 34 formats outgoing information, which can (but need not) be activated by the input devices 40, and conveys the outgoing information to the transceiver 32 for modulation to communication signals. The transceiver 32 conveys the modulated signals to any of a variety of devices including, for example, various nearby devices (e.g., the stereo headset 14, mono headset 15 and/or BlueTooth adapter 16 of FIG. 1) or remote devices (e.g., a cellular transmission tower).

Further as shown in FIG. 2, the input and output devices 38, 40 of the internal components 30 can include a variety of types of visual, audio and/or mechanical input and output devices. For example, the output device(s) 38 can include a visual output device 46 such as a liquid crystal display or a light emitting diode indicator, an audio output device 48 such as a speaker, alarm and/or buzzer, and/or a mechanical output device 50 such as a vibrating mechanism. Likewise, by example, the input devices 40 can include a visual input device 52 such as an optical sensor (for example, a camera), an audio input device 54 such as a microphone, and a mechanical input device 56 such as a flip sensor, a keyboard, a keypad, a mouse, one or more selection buttons, a touch pad, a touch screen, a capacitive sensor, a motion sensor, and a switch. Actions that actuate one or more of the input devices 40 can include, but are not limited to, opening of the cellular telephone, unlocking the device, moving the device to actuate a motion, moving the device to actuate a location positioning system, pressing of a button on the device, and operating the device. Additionally as shown in FIG. 2, the internal components 30 can also include a location circuit 58. Examples of the location circuit 58 include, but are not limited to, a Global Positioning System (GPS) receiver, a triangulation receiver, an accelerometer, a gyroscope, or any other information-collecting device that can identify a current location of the cellular telephone (or one or more of its internal components 30).

The memory portion 36 of the internal components 30 can include any number of a variety of different types of memory devices such as random access memory (RAM) devices, and can be used to store and retrieve data. Typically, although not necessarily, operation of the memory portion 36 in storing and retrieving data is governed by commands from the processor 34. The data that is stored by the memory portion 36 can include, but need not be limited to, operating systems (or other systems software), applications, and data. Each operating system in particular includes executable code that controls basic functions of the cellular telephone, such as interaction among the various internal components 30, communication with external devices via the transceiver 32 and/or the component interface 42, and storage and retrieval of applications and data to and from the memory portion 36. As for the applications, each application includes executable code that operates in conjunction with the operating system to provide more specific functionality for the cellular telephone, such as file system service and handling of protected and unprotected data stored in the memory portion 36. Exemplary applications can include, for example, a discovery application for discovering media on behalf of a user and his/her phone and a download user agent responsible for downloading the media object described by the download descriptor.

As for the data, data is non-executable code or information that can be referenced and/or manipulated by an operating system or application for performing functions of the cellular telephone 12. In accordance with at least some embodiments of the present invention, the data stored in the memory portion 36 in particular includes one or more priority lists such as the BlueTooth priority list 26 shown in FIG. 1. Such priority lists can be added to the memory portion 36 in a variety of ways. For example, the priority lists can be entered by users who are interacting with the cellular telephone by way of the input devices 40, downloaded onto the phone from a remote location, and/or preprogrammed onto the phone.

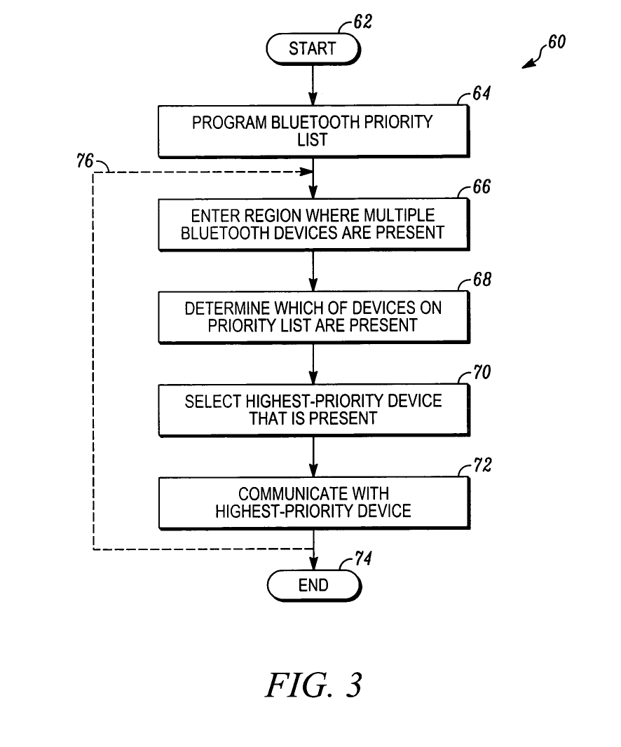

Turning to FIG. 3, a flow chart 60 is provided showing exemplary steps of operation of the cellular telephone 12 of FIGS. 1 and 2, where the steps of operation involve the priority list 26. As shown, after starting operation at step 62, a BlueTooth priority list such as the priority list 26 is provided to the cellular telephone 12 at a step 64. Although as discussed above the priority list 26 can be provided to the cellular telephone 12 (and particularly to the memory 36 of the cellular telephone) in a variety of ways, in step 64 the priority list is programmed into the phone by a user, for example, by selecting from among possible devices that are listed in a drop down menu that is displayed by the phone or by typing in identification information into the telephone using a keypad or other mechanical input 56 of the telephone. Assuming that the cellular telephone 12 has a priority list stored within its memory 36, the cellular telephone 12 then operates in accordance with that priority list as indicated by subsequent steps 66-74.

At step 66 in particular, the cellular telephone 12 enters a region where multiple BlueTooth wireless devices and possibly other devices are present (e.g., the telephone and other BlueTooth wireless devices come into range of one another) and detects the presence of these other devices. For example, in the case of FIG. 1, the cellular telephone 12 detects the presence of each of the stereo headset 14, the mono headset 15, and the car stereo 18 (via the BlueTooth adapter 16) and thus determines the member devices of the wireless communications system 10. Typically, the devices that are present (other than the cellular telephone 12) all will be devices that are listed on the priority list 26 within the cellular telephone 12. At step 68, having detected the BlueTooth and other devices that are present, the cellular telephone 12 next determines which of the devices that are listed on the priority list are in fact present. Subsequently, at step 70, the cellular telephone 12 selects the highest-priority device on the priority list that is present at that time (e.g., in the example of FIG. 1, the car stereo 18 would be identified as the highest-priority device that is present in the wireless communications system 10).

Then, at step 72, the cellular telephone 12 transmits the information of interest to the highest-priority device. Thus, in the example of FIG. 1, the cellular telephone 12 communicates audio streaming information to the BlueTooth adapter 16, which in turn relays/transmits the audio streaming information to the car stereo 18 by way of the FM link 24. Subsequently, the operation of the cellular telephone 12 can be considered to be ended at the step 74 although, as indicated by a dashed line 76, the steps 66-72 can be repeatedly performed as the devices that are within the wireless communication system 10 change over time and the cellular telephone 12 then adapts its behavior in communicating with such devices that are present based upon the priority list 26. For example, as discussed above, if at a later time the BlueTooth adapter 16 is turned off such that the car stereo 18 is no longer present, the cellular telephone 12 then revisits the priority list 26 and determines that (assuming that the stereo headset 14 is present) audio information now should be transmitted to the stereo headset rather than to the car stereo, and does so. Likewise, if the stereo headset 14 then additionally is turned off, then the cellular telephone 12 revisits the priority list 26 again and determines that audio information now should be transmitted to the mono headset 15. Also for example, if at a later time a device with a higher-priority becomes present or is turned on, the cellular telephone 12 can, after revisiting the priority list, enter into communications with that higher-priority device.

It will be understood that FIGS. 1-3 merely show certain exemplary embodiments of the present invention and that the present invention is intended to encompass a wide variety of other embodiments and circumstances. For example, while the present invention involves wireless devices that communicate by way of BlueTooth wireless technology, the present invention is also intended to encompass embodiments that utilize other types of wireless communication technologies. Additionally, while FIG. 1 shows an exemplary wireless communication system 10 that includes four devices (including the cellular telephone 12, and treating the BlueTooth adapter 16 and car stereo 18 as a unit), in other embodiments, only three devices will be present at a given time (if less than three devices are only present, then there is no need for the priority list 26) or more than four devices. While FIG. 1 shows the cellular telephone 12, stereo headset 14, mono headset 15, BlueTooth adapter 16, and car stereo 18, the present invention is applicable with regard to a wide variety of devices and, indeed, to potentially all devices that communicate by way of wireless communications. Thus, the present invention can also be employed in relation to wireless communication systems that involve other types of headsets or speaker systems, notebook or laptop computers that are adapted to allow wireless connectivity, various personal digital assistants, handheld computers or other handheld devices, intercom systems, pagers and other devices.

FIG. 1 is also intended to exemplify that the present invention is applicable to any wireless communication system that includes at least three wireless devices, where one of those devices is hierarchically ordered in relation to the other wireless devices (e.g., in terms of providing information to those devices) and is able to select among those other wireless devices. Further, FIG. 1 is intended to show that, in at least some of these embodiments, the devices that are included on the priority list 26 can be wireless or even non-wireless devices that are in communication only indirectly with the primary wireless device by way of other, secondary (or intermediate) wireless devices of the wireless communication system.

As mentioned above, in some embodiments these secondary or intermediate wireless devices are merely passive relay stations that serve as proxies for the prioritized devices, which for some reason are unable to achieve direct communications with the primary wireless device on which the priority list is located (in such embodiments, the secondary wireless device and prioritized device can be considered to be a single unit/single device). However, in other embodiments, the secondary wireless devices can themselves be listed on the priority list, can include some intelligence, can influence where information being provided by the primary device eventually is provided and/or even can influence the decisions made by the primary device in terms of selecting recipients for information.

Additionally, while the above discussion largely concerns embodiments in which a wireless device at any given time selects a single device from a priority list as being an appropriate device for intercommunications at that time, in alternate embodiments there can also be circumstances in which the wireless device would select multiple devices from a priority list as being appropriate devices for intercommunications at a particular time.

It is specifically intended that the present invention not be limited to the embodiments and illustrations contained herein, but include modified forms of those embodiments including portions of the embodiments and combinations of elements of different embodiments as come within the scope of the following claims.

We claim:

1. A method of operating a first wireless communications device (12,14,15,16,18), the method comprising:
(a) determining which of a plurality of devices identified on a list (26) associated with the first wireless communications device are presently capable of intercommunications with the first wireless communications device (68);
(b) selecting one of the devices that are presently capable of intercommunications with the first wireless communications device as a highest-ranking device based upon a ranking established by the list (70); and
(c) operating the first wireless communications device to achieve intercommunications with the highest-priority device (72).

2. The method of claim 1, further comprising:
positioning the first wireless communications device (12,14,15,16,18) at a first location such that two additional wireless communications devices (12,14,15,16,18) are capable of intercommunications with the first wireless communications device.

3. The method of claim 2, wherein the first wireless communications device (12) has a hierarchical rank that is higher than either of the two additional wireless communications devices (14,15,16,18).

4. The method of claim 3, wherein the first wireless communications device is a cellular telephone (12) that is additionally capable of intercommunications with a cellular tower.

5. The method of claim 2, wherein the plurality of devices identified on the list (26) includes each of the two additional wireless communications devices (14,15,18).

6. The method of claim 5, wherein the plurality of devices identified on the list (26) includes a further device (18) that is incapable of direct intercommunications with the first wireless communications device (12), but is capable of direct intercommunications with one of the additional wireless communications devices (16).

7. The method of claim 6, wherein the further device includes a car stereo (18) that is capable of direct intercommunications with one of the additional wireless communications devices (16) by way of a FM link (24).

8. The method of claim 2, wherein each of the two additional wireless communications devices (14,15,16,18) is selected from the group consisting of a stereo headset, a mono-headset, a cellular telephone, a personal digital assistant, a handheld device, a pager, a BlueTooth adapter and a computer.

9. The method of claim 2, wherein the additional wireless communications devices (14,15,16,18) are capable of intercommunications with the first wireless communications device (12) by way of a plurality of BlueTooth links (20,21,22), and wherein a piconet is formed among the wireless communications devices.

10. The method of claim 1, further comprising:
providing the first wireless communications device (12) with the list (26).

11. The method of claim 10, wherein the list (26) is provided due to preprogramming of the first wireless communications device (12) prior to its being operated by a user, due to downloading of the list from a remote source, or due to programming of the first wireless communications device by the user (64).

12. The method of claim 1, wherein the first wireless communications device (12) transmits audio streaming information to the highest-priority device when operated to achieve intercommunications with the highest-priority device.

13. The method of claim 1, further comprising:
repeating (a)-(c), wherein as a result the first wireless communications device (12) selects and operates to achieve intercommunications with a different highest-priority device (76).

14. A wireless communications device (12,14,15,16,18) comprising:
a transceiver (32);
a memory (36) on which is stored a list (26) of devices with which the wireless communications device can potentially communicate; and
a processing device (34) coupled at least indirectly to the transceiver (32) and the memory (36),
wherein the processing device (34) identifies a plurality of devices on the list (26) that are presently available for communications with the wireless communications device (68), and
wherein the processing device (34) causes the wireless communications device to communicate with a selected one of the identified devices, the selected one identified device being that one of the identified devices which has a relative highest rank on the list (70,72).

15. The wireless communications device of claim 14, wherein the transceiver (32) is configured for wireless communications with at least some of the devices on the list (26) in accordance with a communications specification selected from the group consisting of a BlueTooth specification (20,21,22), an IEEE 802.11 specification, and a HomeRF specification.

16. The wireless communications device of claim 14, wherein the transceiver (32) is configured for wireless communications with at least some of the devices on the list (26) in accordance with a wireless personal-area network (WPAN) communications technology or a wireless local-area network (WLAN) communications technology.

17. The wireless communications device of claim 14, wherein the selected one identified device (18) is only capable of indirect communications with the wireless communications device (12) by way of another wireless communications device (16).

18. The wireless communications device of claim 14, wherein the devices that are identified as being presently available for communications with the wireless communications device vary with time and the selected one identified device also varies with time (76).

19. The wireless communications device of claim 14, wherein the wireless communications device (12,14,15,16,18) is selected from the group consisting of a cellular telephone, a personal digital assistant, a handheld device, a pager, a portable computer and a desktop computer.

20. The wireless communications device of claim 14, further comprising an input device (40,56) selected from the group consisting of a flip sensor, a keyboard, a keypad, a mouse, a selection button, a touch pad, a touch screen, a capacitive sensor, a motion sensor, and a switch, and wherein the list (26) can be input to the wireless communications device (12) by a user via the input device (64).

21. The wireless communications device of claim 14, wherein the wireless communications device (12) transmits information that is selected from the group consisting of voice data, audio data, audio streaming data, image data, data to be printed, data to be faxed, and alphanumeric data to the selected one identified device (14,15,16,18).

22. A primary wireless communications device (12,14,15,16,18) comprising:
means for determining a presence of a plurality of secondary wireless communications devices that are capable of communications with the primary wireless communications device (32,34);
means for selecting a preferred other device from among a plurality of other devices, the plurality of other devices including the secondary wireless communications devices (34,36); and
means for communicating information with the preferred other device (32,34).

23. The primary wireless communications device of claim 22, wherein the primary wireless communications device is capable of communications in accordance with a BlueTooth standard (20,21,22).

24. The primary wireless communications device of claim 22, wherein the means for selecting operates at least in part by consulting a priority list (26).
